(19) United States
(12) Patent Application Publication
(10) Pub. No.: US 2006/0077479 A1
(43) Pub. Date: Apr. 13, 2006

(54) Image reading device and method of scaling up or down image to be read

(75) Inventor: Akihide Itou, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/247,162

(22) Filed: Oct. 12, 2005

(30) Foreign Application Priority Data
Oct. 13, 2004 (JP) 2004-299460

(51) Int. Cl. H04N 1/04

(52) U.S. Cl. 358/474

(57) ABSTRACT

An image reading device is provided which is capable of obtaining an image with satisfactory definition without causing an increase in the number of reading pixels and with reduction in costs. Mirror driving sections change a length of an optical path between an original document and a lens to change a scaling factor of an image to be formed on an image sensor. When high-density reading of a small-sized original document rendering a narrow reading range is required, specified mirrors are rotated to prevent light from travelling through a mirror so as to guide the light into a lens with the decreased number of times of reflection by mirrors occurring during a time period before the light reaches a lens and so that a length of an optical path is shortened, which enables an image, to be formed on an image sensor, to be enlarged.

### BACKGROUND OF THE INVENTION

1. Field of the Invention

The present invention relates to an image reading device and a method of scaling up or down an image to be read, and more particularly to the image reading device in which a module having a light source, image sensor, mirrors, and lens to form a reduced optical image of an original document on the image sensor in its cabinet is configured to scan the original document being fixed on, for example, a flat-shaped contact glass to read an image of the original document and the method of scaling up or down the image to be read, to be used in the image reading device, that is, a method for enlarging or reducing image of the original document.

The present application claims priority of Japanese Patent Application No. 2004-299460 filed on Oct. 13, 2004, which is hereby incorporated by reference.

2. Description of the Related Art

Conventionally, a scanner serving as an image reading device making up an inputting section of, for example, a digital copying machine or facsimile is roughly classified into two types, one employing a contact-type image sensor method by which an image is read by forming an optical conductive film on a substrate having a dimension being the same as a width dimension of an original document (for example, a length of a short side of a rectangular original document) to be read and another employing a reduction-type optical method by which an image is formed by applying illuminating light to an original document from its light source and by using light reflected by the original document and transmitted to an image sensor of a CCD (Charge Coupled Device) or a like through mirrors and lens. Moreover, the reduction-type optical method includes two methods, one being a module-integrated method by which a module having a light source, mirrors, lens, and an image sensor in its cabinet is made to scan an original document and a mirror moving method by which only a light source and mirror move.

However, in either of the above methods, to obtain image data with high definition, an increase in the number of reading pixels per unit length is required. As a result, a problem arises that the increase in the number of pixels causes an area of one pixel to become smaller and an output to decrease and a signal-to-noise (S/N) ratio to become lower. Therefore, it is necessary to increase an amount of light from a light source, to enlarge a diameter of a pupil of a lens, or to reduce a reading speed. Moreover, there is another problem that, due to the increase in the number of pixels, amounts of data for an entire image and of calculation required for image processing become enormous and required storage capacity increases and, as a result, much time is required for the processing, causing costs to become high.

Additionally, another problem arises that, due to the increase in the number of pixels, introduction of a high-priced contact-type image sensor or CCD is required and, in the case of the reduction-type optical method, use of a lens with high resolution is required, causing costs to increase and dimensions to become larger and thus, miniaturization is made difficult.

In an attempt to solve this problem, technology is disclosed in, for example, Japanese Patent Application Laid-open No. Sho 57-6821 in which, to enlarge a reading image in a mirror moving method, image quality is improved, without causing an increase in the number of pixels, by changing positions of mirrors, lens, and image sensor to shorten a length of an optical path between an original document and the lens.

However, the above conventional technology has a problem in that, when optical systems are to be moved, since mirrors or a like are moved forward or backward on an optical axis, a scaling factor of an image can be changed only in a comparatively narrow range and, as a result, definition and/or quality of an image cannot be improved satisfactorily.

### SUMMARY OF THE INVENTION

In view of the above, it is an object of the present invention to provide an image reading device in which an image with satisfactory definition can be obtained, as required, without causing an increase in the number of reading pixels and with reduction in costs, and a method of scaling up or down an image to be read, that can be used in the image reading device.

According to a first aspect of the present invention, there is provided an image reading device including:
an image sensor made up of a plurality of photoelectric converters;
a lens to form an image of an original document to be read on an image pickup plane of the image sensor;
a mirror assembly made up of a plurality of mirror elements placed between the original document and the lens to reflect light having arrived from the original document and to guide the light into the lens;
a scanning module to read information about the image of the original document while scanning in a reading position on the original document;
an image scaling unit to change a length of an optical path between the original document and the lens and to change a scaling factor of an image to be formed on the image pickup plane of the image sensor; and
a focus adjusting unit to change positions of the lens and/or the image sensor along an optical axis and to form the image of the original document on the image pickup plane of the image sensor in a focused state;
wherein the image scaling unit operates at least one specified mirror element but not all to be placed in or removed from the optical path between the original document and the lens so that a length of the optical path between the original document and the lens is changed, whereby the image of the original document to be formed on the image pickup plane of the image sensor is enlarged or reduced.

According to a second aspect of the present invention, there is provided an image reading device including:
an image sensor made up of a plurality of photoelectric converters;
a lens to form an image of an original document to be read on an image pickup plane of the image sensor;
a mirror assembly made up of a plurality of mirror elements placed between the original document and the lens to reflect light having arrived from the original document and to guide the light into the lens;
a scanning module to read information about the image of the original document while scanning in a reading position on the original document;
an image scaling unit to change a length of an optical path between the original document and the lens and to change a scaling factor of an image to be formed on the image pickup plane of the image sensor; and
a focus adjusting unit to change positions of the lens and/or the image sensor along an optical axis and to form the image of the original document on the image pickup plane of the image sensor in a focused state;
wherein the image scaling unit changes an angle or a position of at least one specified mirror element of the mirror assembly so that light having arrived from the original document is guided into the lens with a decreased number of times of reflection by the mirror assembly occurring during a time period before light having arrived from the original document reaches the lens and shortens a length of an optical path between the original document and the lens so that the image of the original document to be formed on the image pickup plane of the image sensor is enlarged.

In the foregoing second aspect, a preferable mode is one wherein the image scaling unit rotates at least one specified mirror element of the mirror assembly to change a direction of reflection of light to be reflected by the mirror elements and does not allow light having arrived from the original document to strike at least one other mirror element of the mirror assembly so that a length of an optical path between the original document and the lens is shortened.

Another preferable mode is one wherein the image scaling unit moves at least one specified mirror element of the mirror assembly out of an optical path and to allow light having arrived from the original document to strike at least one other specified mirror element of the mirror assembly so that a length of the optical path between the original document and the lens is shortened.

Still another preferable mode is one wherein the image is electrically reduced or enlarged by performing thinning-out or interpolation processing on an image signal obtained by the image sensor.

An additional preferable mode is one that wherein further includes a module driving unit to move the scanning module to a specified scanning direction.

According to a third aspect of the present invention, there is provided a method of scaling up or down an image to be read, employed in an image reading device having an image sensor an image sensor made up of a plurality of photoelectric converters, a lens to form an image of an original document to be read on an image pickup plane of the image sensor, a mirror assembly made up of a plurality of mirror elements placed between the original document and the lens to reflect light having arrived from the original document and to guide the light into the lens, a scanning module to read information about the image of the original document while scanning in a reading position on the original document, the method including;
an image scaling step of changing a length of an optical path between the original document and the lens and changing a scaling factor of the image to be formed on the image pickup plane of the image sensor; and
a focus adjusting step of changing positions of the lens and/or the image sensor along an optical axis and forming the image of the original document on the image pickup plane of the image sensor in a focused state;
wherein, in the image scaling step, at least one specified mirror element but not all is operated to be placed in or removed from the optical path between the original document and the lens so that a length of the optical path between the original document and the lens is changed, whereby the image of the original document to be formed on the image pickup plane of the image sensor is enlarged or reduced.

According to a fourth aspect of the present invention, there is provided a method of scaling up or down an image to be read, employed in an image reading device having an image sensor made up of a plurality of photoelectric converters, a lens to form an image of an original document to be read on an image pickup plane of the image sensor, a mirror assembly made up of a plurality of mirror elements placed between the original document and the lens to reflect light having arrived from the original document and to guide the light into the lens and a scanning module to read information about the image of the original document while scanning in a reading position on the original document, the method including;
an image enlarging or reducing step of changing a length of an optical path between the original document and the lens and changing a scaling factor of the image to be formed on the image pickup plane of the image sensor; and
a focus adjusting step of changing positions of the lens and/or the image sensor along an optical axis and forming the image of the original document on the image pickup plane of the image sensor in a focused state;
wherein, in the image enlarging or reducing step, an angle or a position of at least one specified mirror element of the mirror assembly is changed so that light having arrived from the original document is guided into the lens with a decreased number of times of reflection by the mirror assembly occurring during a time period before light having arrived from the original document reaches the lens and a length of an optical path between the original document and the lens is shortened so that the image of the original document to be formed on the image pickup plane of the image sensor is enlarged.

In the foregoing fourth aspect, a preferable mode is one wherein, in the image scaling step, at least one specified mirror element is rotated to change a direction of reflection of light to be reflected by the mirror elements and light having arrived from the original document is not allowed to strike at least one other specified mirror element so that a length of an optical path between the original document and the lens is shortened.

Another preferable mode is one wherein, in the image scaling step, at least one specified mirror element of the mirror assembly is removed from the optical path and light having arrived from the original document is allowed to strike at least one other mirror element of the mirror assembly so that a length of the optical path between the original document and the lens is shortened.

Still another preferable mode is one wherein, in the image scaling step, an image is electrically reduced or enlarged by performing thinning-out or interpolation processing on an image signal obtained by the image sensor.

An addition preferable mode is one that wherein further includes a module driving step of moving the scanning module to a specified scanning direction.

With the above configuration, the image enlarging or reducing means employed in the image reading device changes a length of an optical path between the original document and the lens to cause a change in a scaling factor of the image to be formed on the image sensor, when positions of specified mirror elements making up a mirror assembly are changed to shorten a length of the optical path so that light having reached from the original document is allowed to enter the lens with a decreased number of times of reflection of the light occurring before the light reaches the lens in the mirror assembly and, as a result, the image to be formed on the image sensor is enlarged, which enables the image with satisfactory definition to be obtained, as required, without causing an increase in the number of pixels and with reduction in costs. Moreover, further reduction in costs can be realized simply by adding a driving means serving as an image enlarging and reducing means used to change positions of specified mirror elements to an existing conventional image reading device employing the reduction-type optical means.

### BRIEF DESCRIPTION OF THE DRAWINGS

The above and other objects, advantages, and features of the present invention will be more apparent from the following description taken in conjunction with the accompanying drawings in which:

FIG. 1 is a block diagram schematically showing configurations of a reading module of a scanner according to a first embodiment of the present invention;

FIG. 2 is a block diagram showing configurations of the scanner of FIG. 1;

FIG. 3 is a schematic diagram for explaining configurations of the scanner of FIG. 1;

FIG. 4 is a block diagram showing configurations of an optical driving section making up the reading module of FIG. 1;

FIG. 5 is a schematic diagram for explaining configurations of a mirror driving section making up the optical driving section of FIG. 4;

FIG. 6 is a block diagram showing configurations of a controller of the scanner of FIG. 1;

FIG. 7 is a schematic diagram for explaining operations of the reading module of FIG. 1;

FIG. 8 is a diagram schematically showing configurations of a reading module of a scanner according to a second embodiment of the present invention; and

FIG. 9 is a schematic diagram for explaining operations of the scanner of the second embodiment.

### DETAILED DESCRIPTION OF THE PREFERRED EMBODIMENTS

Best modes of carrying out the present invention will be described in further detail using various embodiments with reference to the accompanying drawings. In the embodiment, an image enlarging or reducing means changes a length of an optical path between an original document and a lens so that a scaling factor of an image to be formed on an image sensor is changed, when positions of specified mirror elements making up a mirror assembly are changed to shorten the length of the optical path in a manner in which light having reached from the original document is allowed to enter the lens with the decreased number of reflections of the light occurring before the light reaches the lens in the mirror assembly. As a result, an image to be formed on the image sensor is enlarged, thus achieving an aim that an image with satisfactory definition can be obtained as required without causing an increase in the number of pixels and with reduction in costs.

### First Embodiment

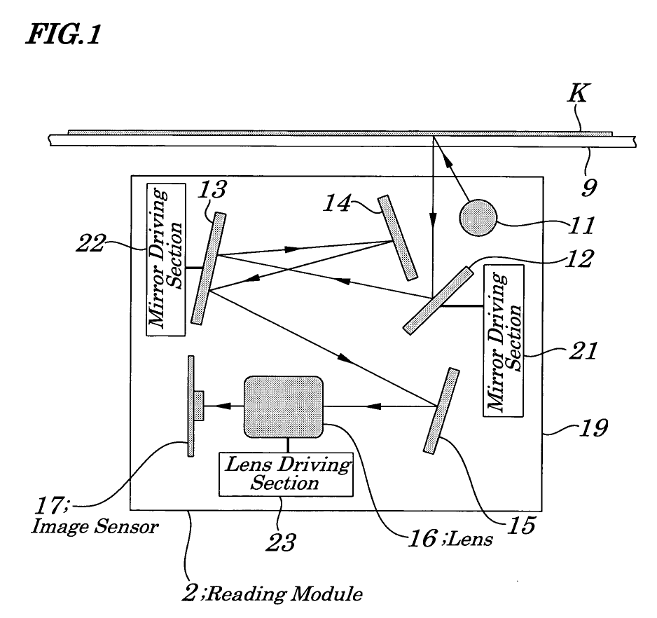

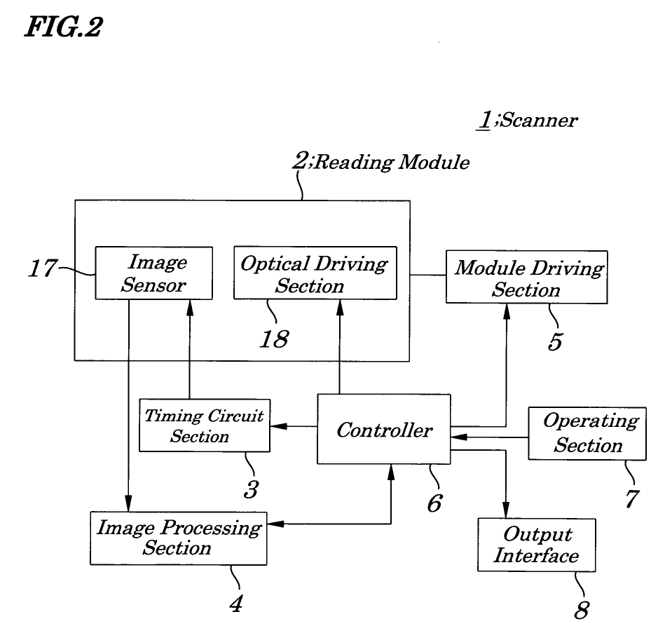

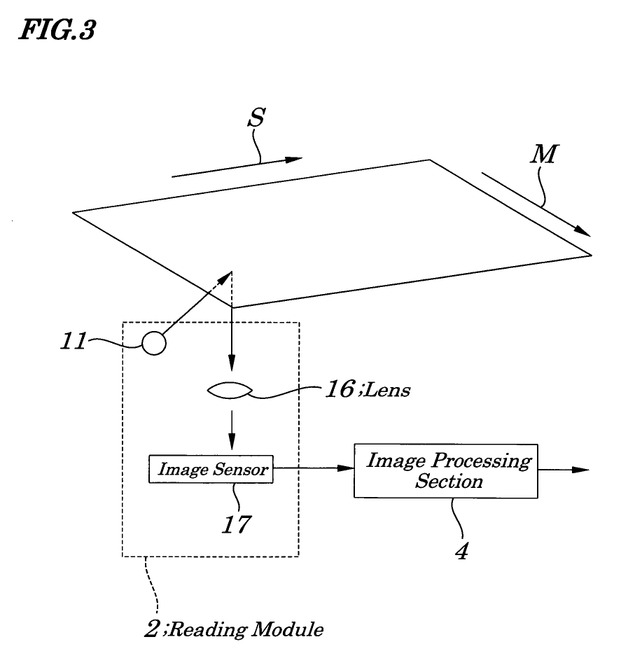

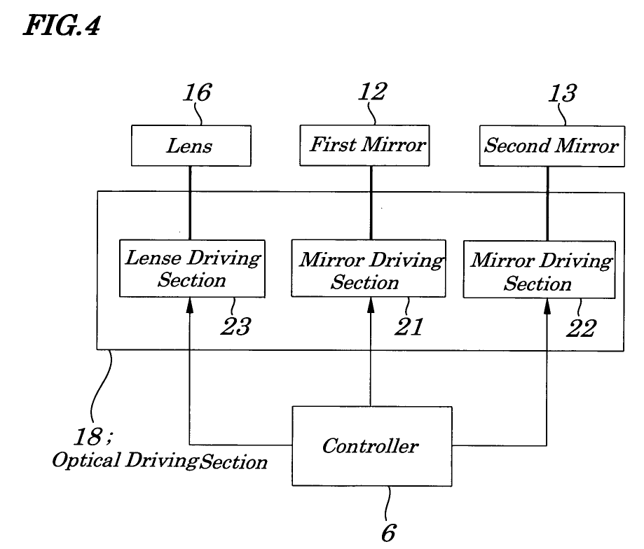

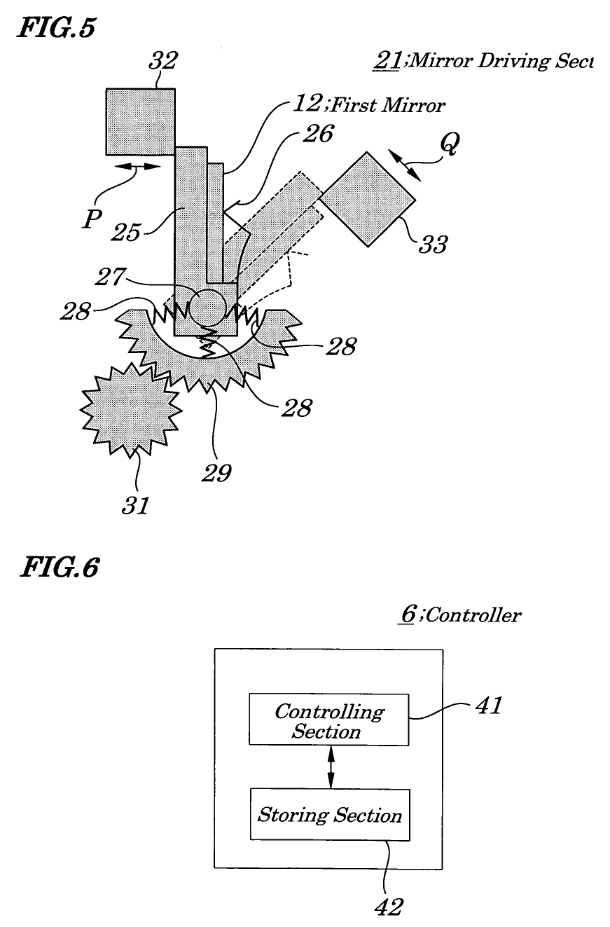

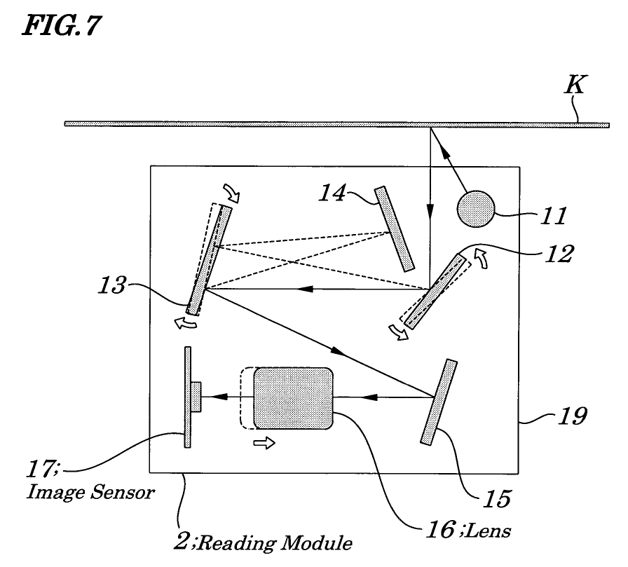

FIG. 1 is a diagram schematically showing configurations of a reading module 2 of a scanner 1 according to a first embodiment of the present invention. FIG. 2 is a block diagram showing configurations of the scanner 1 of FIG. 1. FIG. 3 is a schematic diagram for explaining configurations of the scanner 1 of FIG. 1. FIG. 4 is a block diagram showing configurations of an optical driving section 18 of the reading module of FIG. 1. FIG. 5 is a schematic diagram for explaining configurations of a mirror driving section 21 making up the optical driving section 18 of FIG. 4. FIG. 6 is a block diagram showing configurations of a controller 6 of the scanner 1 of FIG. 1. FIG. 7 is a schematic diagram for explaining operations of the reading module 2 of FIG. 1.

The scanner 1, as shown in FIG. 1, performs operations of reading of an original document along a main scanning direction M (FIG. 3), which includes the reading module 2 (FIG. 2) being movable along a sub-scanning direction S (FIG. 3), a timing circuit section 3 to feed a timing signal to an image sensor 17 of the reading module 2, an image processing section 4 to process image signals obtained from the image sensor 17, a module driving section 5 to move the reading module 2 along the sub-scanning direction S, a controller 6 to control each of the components, an operating section 7 that can switch definition of an image and/or can do setting of a scaling factor of the image, and an output interface 8 used to transfer image data to, for example, a host computer (not shown). Moreover, in FIG. 1, a contact glass 9 is shown on which an original document K is put in a fixed manner.

The reading module 2 includes a light source 11 made up of, for example, a fluorescent lamp, a first mirror 12, a second mirror 13, a third mirror 14, and a fourth mirror 15, all being placed on an optical path and operating to reflect light having arrived from the original document K to guide it into a lens 16 which forms an image of the original document K on the image sensor 17 made up of a linear CCD array, an optical driving section 18 to change a scaling factor of an image by driving the first mirror 12, the second mirror 13 and/or the lens 16 to change a length between the original document K and the lens 16, and a cabinet 19 housing the light source 11, the first mirror 12, the second mirror 13, the third mirror 14, the fourth mirror 15, the lens 16, the image sensor 17, and the optical driving section 18.

The optical driving section 18, as shown in FIG. 4, includes the mirror driving section 21 to drive the first mirror 12 to rotate (or swing) to the right or the left in accordance with instructions from the controller 6, a mirror driving section 22 to drive the second mirror 13 to rotate to the right or the left in accordance with instructions from the controller 6, and a lens driving section 23 to move the lens 16 forward or backward on an optical axis, in accordance with instructions from the controller 6.

The mirror driving section 21, as shown in FIG. 5, includes, for example, mirror fixing brackets 25 and 25 to hold both-side portions of the first mirror 12, fixed springs 26 and 26 to press the first mirror 12 from a front side for fixing, a rotating shaft 27, being fixed to the cabinet 19 in a rotatable manner, to cause the mirror fixing brackets 25 and 25 to rotate to the right or the left, an arc-shaped rack 29 attached to the rotating shaft 27 by using elastic members 28, 28, and 28 made up of compressed springs or a like, a pinion 31 being engaged in the arc-shaped rack 29, stoppers 32 and 33 to regulate a range of the rotation, an actuator (not shown) such as a stepping motor to give the pinion 31 mechanical force to rotate to the light or the left.

Here, the first mirror 12 is fixed in each of specified rotational positions by regulation applied by each of the stoppers 32 and 33. Moreover, a position of each of the stoppers 32 and 33 can be changed along directions P and Q and can be adjusted so that each of the stoppers 32 and 33 is fixed in advance in an optimum position. Moreover, the pinion 31 is so controlled as to rotate in a somewhat wider range and, therefore, by deformation of the elastic member 28, the mirror fixing bracket 25 is made to strike the stoppers 32 and 33 with reliability. The mirror driving section 22 has configurations being approximately the same as those of the mirror driving section 21. The lens driving section 23 has, for example, a lens holder to hold the lens 16, a rack attached to the lens holder in a manner in which its teeth are placed along the optical axis, a pinion being engaged in the rack, and a driving motor to give the pinion mechanical force to rotate to the right or the left.

The image processing section 4 (FIG. 3), after having performed an A/D (Analog to Digital) processing, performs gray-scaling processing, shading correction processing, MTF (Modulation Transfer Function) processing, gamma correction processing, or a like and image enlarging or reducing processing based, for example, on a set scaling factor, definition switching operations, or a like.

The module driving section 5 has a stepping motor (not shown) serving as an actuator. The controller 6, as shown in FIG. 6, has a controlling section 41 to control the reading module 2 and/or the image processing section 4 and a storing section 42 to store processing programs to be executed by the controlling section 41, various data or a like.

The controlling section 41 is made up of a CPU (Central Processing Unit) or a like which executes each of various processing programs stored in the storing section 42 and controls each component making up the scanner 1 proper. The controlling section 41, based on each of processing programs stored in the storing section 42, for example, makes the image processing section 4 perform the image enlarging or reducing processing and also performs actuator driving control processing to control the mirror driving sections 21 and 22 making up the optical driving section 18, lens driving section 23, module driving section 5 or a like.

The storing section 42 is made up of a semiconductor memory such as a ROM (Read Only Memory), RAM (Random Access Memory), or a like, which has an information storing section in which various kinds of information is stored and a program storing section to store various processing programs to be executed by the controlling section 41.

Next, operations of the scanner 1 of the embodiment are described by referring to FIG. 7.

For example, if reading of a small-sized original document K rendering a narrow reading range such as a photograph, film, or a like is required, when an operator performs, using the operating section 7, operations of switching to a high-definition mode in which reading with comparatively high definition is made possible, the controlling section 41 controls the mirror driving sections 21 and 22 and lens driving section 23 to rotate the first mirror 12 and second mirror 13 to a specified angle, as shown in FIG. 7, so that the third mirror 14 is removed from the optical path between the original document K and the image sensor 17 to shorten a length of an optical path and changes a position of the lens 16 on the optical axis in a direction in which the lens 16 is away from the image sensor 17 to adjust a distance between the lens 16 and image sensor 17 in a manner in which focusing of the image is achieved. As a result, an image of the original document K is formed on the image sensor 17.

Therefore, the light having arrived from the original document K is reflected by the first mirror 12 and second mirror 13 and reaches the fourth mirror 15 without travelling by way of the third mirror 14 and is then reflected by the fourth mirror 15 to be guided into the lens 16 and, as a result, an enlarged image of the original document K is formed on the image sensor 17.

Thus, the specified mirrors 12 and 13 are made to be rotated so that light is guided into the lens 16 with the decreased number of times of reflection by the mirrors 12, 13, 14, and 15 occurring during a time period before the light reaches the lens 16; that is, a length of an optical path is shortened by preventing the light from travelling by way of the mirror 14 so that an image to be formed on the image sensor 17 is enlarged.

For example, in the case where a scaling factor of an image is preset at “n”, the controlling section 41 controls the optical driving section 18 so that an original document K is read to select arrangement of the mirrors out of possible arrangements in a manner in which the selected arrangement corresponds to a scaling factor “m” being nearest to the set scaling factor “n” and also controls the image processing section 4 so that thinning-out processing by which image data is reduced or interpolation processing by which interpolation data is generated by estimation based on data obtained before and after the processing is performed and so that scaling factor correcting processing by which the scaling factor becomes “n/m” is performed. Thus, mainly by optically switching a scaling factor of an image to be formed, it is made possible to obtain an image being free from degradation of image quality and being able to be formed by an arbitrary scaling factor.

On the other hand, if reading of a large-sized original document K rendering a wide range of reading such as a book or a like is required, an operator performs operations of switching to a normal mode using the operating section 7, so that the controlling section 41 reads the original document K in relatively coarse density of an object point.

As described above, according to the image reading device of the embodiment, the mirror driving sections 21 and 22 change a length of an optical path between the original document K and lens 16 so that a scaling factor of an image to be formed on the image sensor 17 is changed. For example, if reading of a small-sized original document K rendering a narrow range of reading such as a photograph, film, or a like is required, the specified mirrors 12 and 13 are rotated so that light having arrived from the original document K is guided into the lens 16 with the decreased number of times of reflection by the mirrors 12, 13, 14, and 15 occurring during a time period before the light reaches the lens 16; that is, a length of an optical path is shortened by preventing the light from travelling by way of the third mirror 14 so that an image to be formed on the image sensor 17 is enlarged and, therefore, an image with satisfactory definition can be obtained, as required, without causing an increase in the number of reading pixels.

That is, when an image is to be read at a comparatively high definition level, since an optimum reduction optical system is realized by shortening a length of an optical path between the original document K and the lens 16, comparatively high resolution of an image represented as, for example, high MTF (Modulation Transfer Function) and sufficiently high output can be obtained, thus achieving images with high definition and high quality.

Moreover, the image reading device of the embodiment is achieved without causing an increase in the number of reading pixels and, therefore, an amount of data to be processed and required storage capacity can be maintained at a low level and introduction of a high-priced CCD or lens with high resolution is not necessary, which can reduce its manufacturing costs and enables miniaturization of the device.

Moreover, since the number of reading pixels is not increased and a scaling factor of an image is optically changed by changing a length of an optical path, if reading of a large-sized original document rendering a wide range of reading such as a book or a like is required, there is useless data and a sufficient amount of light can be obtained and time required in photoelectric conversion is made short and, therefore, an original document rendering a wide range of reading can be read at high speed. Additionally, the image reading device can be realized simply by adding the mirror driving sections 21 and 22 serving as an image enlarging and reducing means used to change positions of specified mirrors to the existing image reading device of a reduction-optical type and, therefore, development costs or manufacturing costs can be reduced which enables further reduction of costs.

### Second Embodiment

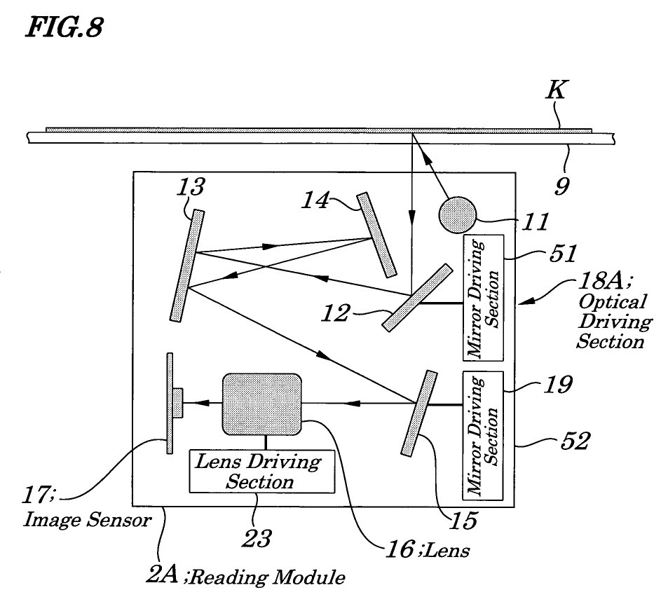

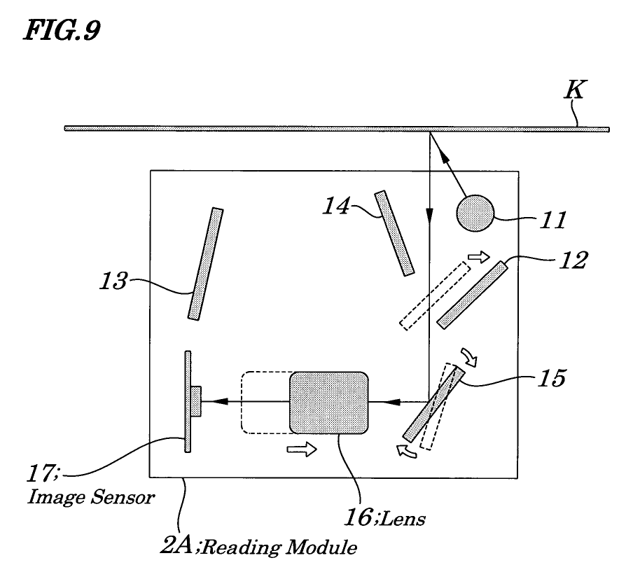

FIG. 8 is a diagram schematically showing configurations of a reading module 2A of a scanner according to a second embodiment of the present invention. FIG. 9 is a schematic diagram for explaining operations of the scanner of the second embodiment.

Configurations of the reading module 2A of the second embodiment differ from those of the reading module 2 of the first embodiment in that a first mirror 12 is moved out of an optical path and a fourth mirror 15 is made to be driven. Configurations other than described here are approximately the same as those of the first embodiment and their descriptions are omitted or simplified accordingly, by using a same numeral in FIG. 8, concerning a same component as that shown in FIG. 5.

A reading module 2A of the scanner of the second embodiment, as shown in FIG. 8, includes a light source 11, a first mirror 12, second mirror 13, third mirror 14, and fourth mirror 15 all being arranged on an optical path to reflect light having arrived from an original document K so as to guide the reflected light into a lens 16, an image sensor 17 made up of linear CCD arrays, an optical driving section 18A to change a scaling factor of an image by driving the first mirror 12, second mirror 13 and/or lens 16 to change a length of an optical path between the original document K and lens 16, and a cabinet 19 housing the light source 11, first mirror 12, second mirror 13, third mirror 14, fourth mirror 15, lens 16, image sensor 17 and optical driving section 18A.

The optical driving section 18, as shown in FIG. 8, has a mirror driving section 51 to move the first mirror 12 out of the optical path, a mirror driving section 52 to drive the fourth mirror 15 to rotate to the right or left, and a lens driving section 23 to move the lens 16 forward or backward on an optical axis. Configurations of the mirror driving section 51 of the second embodiment are the same as those of the lens driving section 23 of the first embodiment. Also, configurations of the mirror driving section 52 are the same as those of the lens driving section 21 of the first embodiment.

Next, operations of the scanner of the second embodiment are described by referring to FIG. 9.

For example, if reading of a small-sized original document K rendering a narrow reading range such as a photograph, film, or a like is required, an operator performs, using the operating section 7, operations of switching to a high definition mode in which reading of the original document with high definition is made possible and, as a result, the controlling section 41 controls the mirror driving sections 51 and 52 making up the optical driving section 18A and/or the lens driving section 23, as shown in FIG. 9, to move the first mirror 12 forward side by side so that the first mirror 12 is moved out of an optical path and so that light having arrived from the original document K directly reaches the fourth mirror 15 without travelling by way of the second mirror 13 and third mirror 14 and the controlling section 41 controls the fourth mirror 15 to rotate to a specified angle to cause the light having arrived from the original document K to be reflected toward the lens 16 so as to shorten a length of an optical path and to move the lens 16 and change a position of the lens 16 in a direction in which the lens 16 is away from the image sensor 17 so that a distance between the lens 16 and image sensor 17 is adjusted in a focused state.

Thus, light having arrived from the original document K is reflected by the fourth mirror 15 and reaches the fourth mirror 15 without travelling by way of the first mirror 12, second mirror 13, and third mirror 14 and then is reflected by the fourth mirror 15 to be guided into the lens 16 and, as a result, an enlarged image is formed on the image sensor 17.

In the second embodiment, the same effect obtained by the first embodiment can be achieved.

It is apparent that the present invention is not limited to the above embodiments but may be changed and modified without departing from the scope and spirit of the invention. For example, in the above embodiments, four mirrors are employed. However, the present invention is not limited to this. Two mirrors may be also used. Five or more mirrors may be also used. Also, in the above embodiment, a scaling factor of an image is switched in two stages, however, switching in three or more stages is made possible by newly adding the mirror driving section. Moreover, switching in four stages is made possible by combining configurations of the first and second embodiments.

Also, to achieve focusing, the image sensor may be moved backward with the lens being fixed. The lens and image sensor may be moved in a direction away from each other.

The present invention may be applied to a color scanner. Also, if a port on an output side is connected, for example, to a printer, the image reading device may be so configured that a scaling factor of an image may be automatically set based on a size of an original document and a size of printing paper on an output side. Furthermore, the lens driving section may be made up of a ball screw attached to a lens holder and a driving motor to rotate the ball screw.

The present invention may also be applied to a case where a photodiode array, in addition to a CCD, is used as a photoelectric converter.

What is claimed is:

1. An image reading device comprising:
an image sensor made up of a plurality of photoelectric converters;
a lens to form an image of an original document to be read on an image pickup plane of said image sensor;
a mirror assembly made up of a plurality of mirror elements placed between said original document and said lens to reflect light having arrived from said original document and to guide the light into said lens;
a scanning module to read information about the image of said original document while scanning in a reading position on said original document;
an image scaling unit to change a length of an optical path between said original document and said lens and to change a scaling factor of an image to be formed on said image pickup plane of said image sensor; and
a focus adjusting unit to change positions of said lens and/or said image sensor along an optical axis and to form the image of said original document on said image pickup plane of said image sensor in a focused state;
wherein said image scaling unit operates at least one specified mirror element but not all to be placed in or removed from the optical path between said original document and said lens so that a length of said optical path between said original document and said lens is changed, whereby the image of said original document to be formed on said image pickup plane of said image sensor is enlarged or reduced.

2. An image reading device comprising:
an image sensor made up of a plurality of photoelectric converters;
a lens to form an image of an original document to be read on an image pickup plane of said image sensor;
a mirror assembly made up of a plurality of mirror elements placed between said original document and said lens to reflect light having arrived from said original document and to guide the light into said lens;
a scanning module to read information about the image of said original document while scanning in a reading position on said original document;
an image scaling unit to change a length of an optical path between said original document and said lens and to change a scaling factor of an image to be formed on said image pickup plane of said image sensor; and
a focus adjusting unit to change positions of said lens and/or said image sensor along an optical axis and to form the image of said original document on said image pickup plane of said image sensor in a focused state;
wherein said image scaling unit changes an angle or a position of at least one specified mirror element of said mirror assembly so that light having arrived from said original document is guided into said lens with a decreased number of times of reflection by said mirror assembly occurring during a time period before light having arrived from said original document reaches said lens and shortens a length of an optical path between said original document and said lens so that the image of said original document to be formed on said image pickup plane of said image sensor is enlarged.

3. The image reading device according to claim 2, wherein said image scaling unit rotates at least one specified mirror element of said mirror assembly to change a direction of reflection of light to be reflected by said mirror elements and does not allow light having arrived from said original document to strike at least one other mirror element of said mirror assembly so that a length of an optical path between said original document and said lens is shortened.

4. The image reading device according to claim 2, wherein said image scaling unit moves at least one specified mirror element of said mirror assembly out of an optical path and to allow light having arrived from said original document to strike at least one other specified mirror element of said mirror assembly so that a length of said optical path between said original document and said lens is shortened.

5. The image reading device according to claim 2, wherein the image is electrically reduced or enlarged by performing thinning-out or interpolation processing on an image signal obtained by said image sensor.

6. The image reading device according to claim 2, further comprising a module driving unit to move said scanning module to a specified scanning direction.

7. A method of scaling up or down an image to be read, employed in an image reading device having an image sensor an image sensor made up of a plurality of photoelectric converters, a lens to form an image of an original document to be read on an image pickup plane of said image sensor, a mirror assembly made up of a plurality of mirror elements placed between said original document and said lens to reflect light having arrived from said original document and to guide the light into said lens, a scanning module to read information about the image of said original document while scanning in a reading position on said original document, said method comprising;
an image scaling step of changing a length of an optical path between said original document and said lens and changing a scaling factor of the image to be formed on said image pickup plane of said image sensor; and
a focus adjusting step of changing positions of said lens and/or said image sensor along an optical axis and forming the image of said original document on said image pickup plane of said image sensor in a focused state;
wherein, in said image scaling step, at least one specified mirror element but not all is operated to be placed in or removed from the optical path between said original document and said lens so that a length of said optical path between said original document and said lens is changed, whereby the image of said original document to be formed on said image pickup plane of said image sensor is enlarged or reduced.

8. A method of scaling up or down an image to be read, employed in an image reading device having an image sensor made up of a plurality of photoelectric converters, a lens to form an image of an original document to be read on an image pickup plane of said image sensor, a mirror assembly made up of a plurality of mirror elements placed between said original document and said lens to reflect light having arrived from said original document and to guide the light into said lens and a scanning module to read information about the image of said original document while scanning in a reading position on said original document, said method comprising;
an image enlarging or reducing step of changing a length of an optical path between said original document and said lens and changing a scaling factor of the image to be formed on said image pickup plane of said image sensor; and
a focus adjusting step of changing positions of said lens and/or said image sensor along an optical axis and forming the image of said original document on said image pickup plane of said image sensor in a focused state;
wherein, in said image enlarging or reducing step, an angle or a position of at least one specified mirror element of said mirror assembly is changed so that light having arrived from said original document is guided into said lens with a decreased number of times of reflection by said mirror assembly occurring during a time period before light having arrived from said original document reaches said lens and a length of an optical path between said original document and said lens is shortened so that the image of said original document to be formed on the image pickup plane of said image sensor is enlarged.

9. The method of scaling up or down an image to be read according to claim 8, wherein, in said image scaling step, at least one specified mirror element is rotated to change a direction of reflection of light to be reflected by said mirror elements and light having arrived from said original document is not allowed to strike at least one other specified mirror element so that a length of an optical path between said original document and said lens is shortened.

10. The method of scaling up or down an image to be read according to claim 8, wherein, in said image scaling step, at least one specified mirror element of said mirror assembly is removed from the optical path and light having arrived from said original document is allowed to strike at least one other mirror element of said mirror assembly so that a length of said optical path between said original document and said lens is shortened.

11. The method of scaling up or down an image to be read according to claim 8, wherein, in said image scaling step, an image is electrically reduced or enlarged by performing thinning-out or interpolation processing on an image signal obtained by said image sensor.

12. The method of scaling up or down an image to be read according to claim 8, further comprising a module driving step of moving said scanning module to a specified scanning direction.

13. An image reading device comprising:
an image sensor made up of a plurality of photoelectric converters;
a lens to form an image of an original document to be read on an image pickup plane of said image sensor;
a mirror assembly made up of a plurality of mirror elements placed between said original document and said lens to reflect light having arrived from said original document and to guide the light into said lens;
a scanning means to read information about the image of said original document while scanning in a reading position on said original document;
an image scaling means to change a length of an optical path between said original document and said lens and to change a scaling factor of an image to be formed on said image pickup plane of said image sensor; and
a focus adjusting means to change positions of said lens and/or said image sensor along an optical axis and to form the image of said original document on said image pickup plane of said image sensor in a focused state;
wherein said image scaling means operates at least one specified mirror element but not all to be placed in or removed from the optical path between said original document and said lens so that a length of said optical path between said original document and said lens is changed, whereby the image of said original document to be formed on said image pickup plane of said image sensor is enlarged or reduced.

14. An image reading device comprising:
an image sensor made up of a plurality of photoelectric converters;
a lens to form an image of an original document to be read on an image pickup plane of said image sensor;
a mirror assembly made up of a plurality of mirror elements placed between said original document and said lens to reflect light having arrived from said original document and to guide the light into said lens;
a scanning means to read information about the image of said original document while scanning in a reading position on said original document;
an image scaling means to change a length of an optical path between said original document and said lens and to change a scaling factor of an image to be formed on said image pickup plane of said image sensor; and
a focus adjusting means to change positions of said lens and/or said image sensor along an optical axis and to form the image of said original document on said image pickup plane of said image sensor in a focused state;
wherein said image scaling means changes an angle or a position of at least one specified mirror element of said mirror assembly so that light having arrived from said original document is guided into said lens with a decreased number of times of reflection by said mirror assembly occurring during a time period before light having arrived from said original document reaches said lens and shortens a length of an optical path between said original document and said lens so that the image of said original document to be formed on said image pickup plane of said image sensor is enlarged.

15. The image reading device according to claim 14, wherein said image scaling means rotates at least one specified mirror element of said mirror assembly to change a direction of reflection of light to be reflected by said mirror elements and does not allow light having arrived from said original document to strike at least one other mirror element of said mirror assembly so that a length of an optical path between said original document and said lens is shortened.

16. The image reading device according to claim 14, wherein said image scaling means moves at least one specified mirror element of said mirror assembly out of an optical path and to allow light having arrived from said original document to strike at least one other specified mirror element of said mirror assembly so that a length of said optical path between said original document and said lens is shortened.
